(19) United States
(12) Patent Application Publication
(10) Pub. No.: US 2012/0242839 A1
(43) Pub. Date: Sep. 27, 2012

(54) IMAGE SENSOR CALIBRATION SYSTEM AND METHOD

(75) Inventor: Shi SHEN, Farmington Hills, MI (US)

(73) Assignee: TK Holdings Inc.

(21) Appl. No.: 13/428,775

(22) Filed: Mar. 23, 2012

Related U.S. Application Data
(60) Provisional application No. 61/467,863, filed on Mar. 25, 2011.
(60) Provisional application No. 61/467,827, filed on Mar. 25, 2011.

(51) Int. Cl. H04N 17/06

(52) U.S. Cl. 348/187; 348/E17.002

(57) ABSTRACT

A calibration apparatus includes a calibration target such as a checkerboard, a frame configured to hold the checkerboard in place, a rotatable socket connected at one end to the frame, a stand which is connected to another end of the rotatable socket, a height adjusting portion connected at one end to the stand, and a platform connected to another end of the stand. The checkerboard can be tilted and moved to a particular distance and orientation with respect to an image system to be calibrated by the calibration apparatus. A method of identifying outlier images in the camera parameter estimation process, by using estimated 3D positions of the checkerboard compared with ground truth values.

### CROSS-REFERENCE TO RELATED PATENT APPLICATION

This application claims priority from Provisional Application 61/467,827; filed Mar. 25, 2011, incorporated herein by reference in its entirety. This application also claims priority from Provisional Application 61/467,863; filed Mar. 25, 2011, incorporated herein by reference in its entirety.

### FIELD OF THE INVENTION

The present disclosure relates generally to the field of driver assistance systems. The present disclosure more specifically relates to image sensor calibration systems and methods for a driver assistance system.

### BACKGROUND OF THE INVENTION

Driver assistance systems are becoming more and more popular for vehicles. Many driver assistance systems use one or more image sensors to capture images of the surrounding environment of the host vehicle in order to detect vehicles, pedestrians, obstacles, lanes, and traffic scenarios for warning the driver of potential dangers of collision, or activating automatic vehicle responses to avoid or mitigate collisions. To measure distances to detected objects, these image sensors have to be calibrated using a predefined target with known shape and size.

As such, there is a need to perform calibration of vehicle image sensors, so as to correctly detect and measure distances to all objects in the detection zone for accurate collision avoidance or mitigation.

### SUMMARY OF THE INVENTION

According to one exemplary embodiment, a calibration apparatus includes a calibration target; a frame configured to hold the calibration target in place; a rotatable socket connected at one end to the frame; a stand which is connected to another end of the rotatable socket; a height adjusting portion connected at one end to the stand; and a platform connected to another end of the stand. The calibration target can be tilted and moved to a particular distance and orientation with respect to an image sensor to be calibrated by the calibration apparatus.

According to yet another exemplary embodiment, a calibration apparatus includes a movable platform; a calibration target held on the movable platform; a rotating unit configured to rotate the calibration target on the movable platform; and a height adjusting unit configured to adjust a height of the calibration target on the movable platform. The calibration target can be tilted and moved to a particular distance and orientation with respect to an image sensor to be calibrated by the calibration apparatus.

According to another aspect of the invention, an image calibration method includes capturing predetermined images used during calibration at a plurality of predefined positions and orientations with respect to an imaging system to be calibrated. The method also includes, based on the captured images at the plurality of predefined positions and orientations, forming a parameter set of images. The method further includes performing a calibration optimization process which includes obtaining a plurality of images at particular positions and orientations with respect to the imaging system to be calibrated. The method also includes using the parameter set of images to determine whether any of the images obtained during the calibration optimization process are to be categorized as outlier images and thereby removed.

### BRIEF DESCRIPTION OF THE DRAWINGS

The features, aspects, and advantages of the present invention will become apparent from the following description and accompanying exemplary embodiments shown in the drawings, which are briefly described below.

FIG. 1 is an illustration showing checkerboard positions for use in performing a calibration method according to an exemplary embodiment.

FIG. 2 is a graph of a pitch angle calculation based on checkerboard positions, according to an exemplary embodiment.

FIG. 3 is a graph of a yaw angle calculation based on checkerboard positions, according to an exemplary embodiment.

FIG. 4 is a graph of a roll angle calculation based on checkerboard positions, according to an exemplary embodiment.

FIG. 5 is a diagram showing a calibration apparatus according to an exemplary embodiment.

FIG. 6 is a diagram showing a rotatable joint that can be used in the calibration apparatus according to an exemplary embodiment.

FIG. 7 is an illustration of a checkerboard in a high distortion region used as a calibration object, according to an exemplary embodiment.

FIG. 8 is a graph of a reprojection error distribution based on a prior art method of identifying outlier images, according to an exemplary embodiment.

FIG. 9 is a top view of checkerboard positions for the method of identifying outlier images, according to an exemplary embodiment.

FIG. 10 is a front view of checkerboard positions for the method of identifying outlier images, according to an exemplary embodiment.

### DETAILED DESCRIPTION

Some embodiments of the present invention are directed to a method for automatically measuring and calculating camera pitch, yaw, and roll angles. The method can be used such that image-ground transformation can be carried out correctly. This method can be used by a camera calibration system for a driver assistance system of a vehicle, according to an exemplary embodiment. Other embodiments of the present invention are directed to remove outlier images to improve the intrinsic parameters calibration accuracy.

In machine vision applications, because of lens distortion and imperfect lens mounting, camera calibration is an important step to determine the internal camera geometric and optical characteristics in order to extract accurate metric information from 2D images. Calibration is typically performed by observing and capturing images of a calibration object whose geometry in 3D space is known with very good precision, followed by a parameter estimation process using some calibration software. The most commonly used calibration object is a painted checkerboard with precisely known square size, and corner positions of each square in the image are used in the parameter estimation process.

Since the estimated principal point (optical center) of a camera varies from calibration to calibration, the stereo camera's pitch, yaw, and roll angles also change with each calibration. This variation causes problem in pitch sensitive applications such as lane departure warning, unless the correct pitch is measured or calculated after each calibration. A conventional method of calibrating the pitch, yaw, and roll angles involves measuring the ground truth of at least 4 ground points (downrange and cross range); ground point image capturing and rectification; feature point extraction from the rectified image of the ground points (currently manual); and calculation of the projection matrix and the 3 rotation angles.

One challenge is that the measurement (downrange, cross range) of the 4 ground points needs to be accurate, and a flat ground of 7 meters long in front of the camera is usually needed when the camera is installed on a vehicle. This, however, can not be easily done in a timely manner in a garage.

A method of calibrating the camera pitch, yaw, and roll angles according to an exemplary embodiment includes a mobile checkerboard and the usage of it in a specific way. This mobile checkerboard is a planar checkerboard that is mounted on a frame that can firmly hold it. The checkerboard frame is mounted on a metal socket through a universal joint that allows the frame to be able to freely move and stop at any orientation. The frame socket is mounted on a supporting stand with adjustable height, so that the elevation of the checkerboard can be adjusted in a predetermined range, e.g., a range of at least 500 mm vertically. The supporting stand is firmly mounted on a wheeled cart or platform, so that the checkerboard can be moved freely on the ground. The cart or platform is heavy enough to hold the framed checkerboard stably in motion.

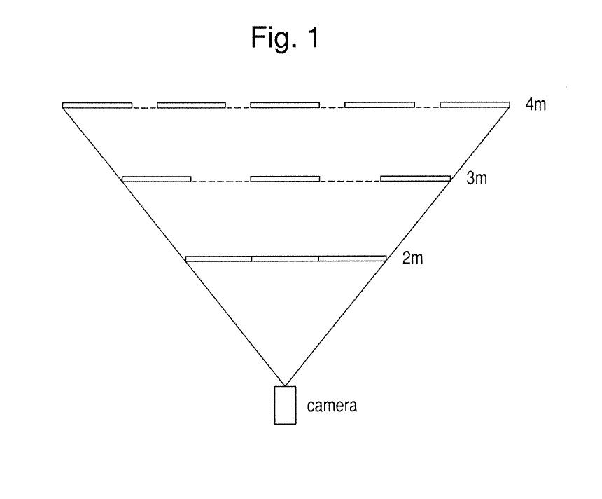

According to an exemplary embodiment, the checkerboard elevation should be fixed at the same value throughout the entire calibration. The elevation should make the checkerboard totally inside the camera's vertical FOV at 2 meter range. The checkerboard images are to be captured at 3 (or more) predefined downranges. The checkerboard images are to be captured at multiple positions at each predefined range. The checkerboard images are to be captured at multiple orientations at each position and each range. An example of the checkerboard positions is described in FIG. 1. An example of multiple orientations at each position at each range can be orientations between −20 degree and +20 degree around the X, Y, and Z axis.

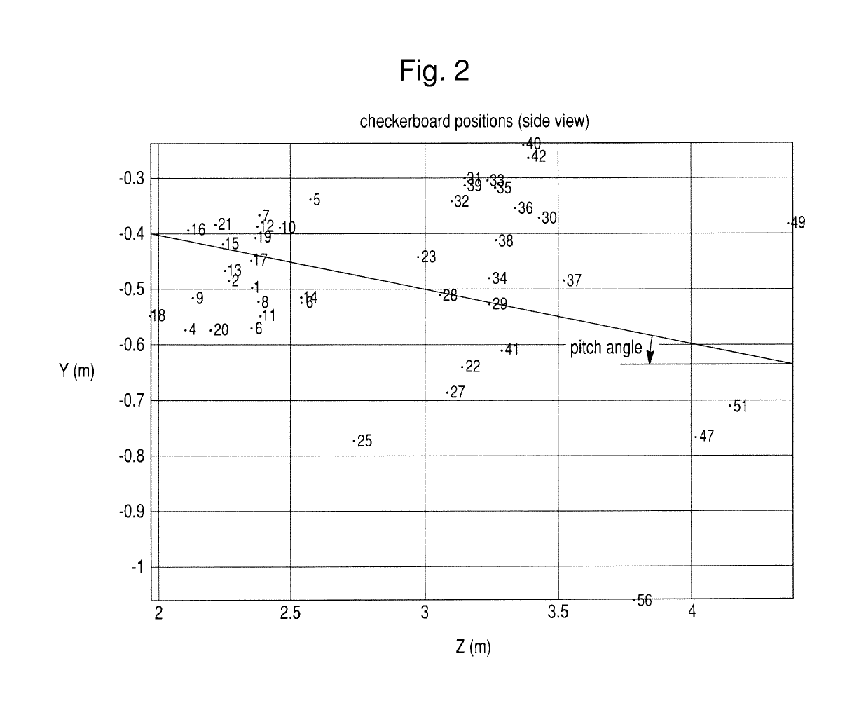

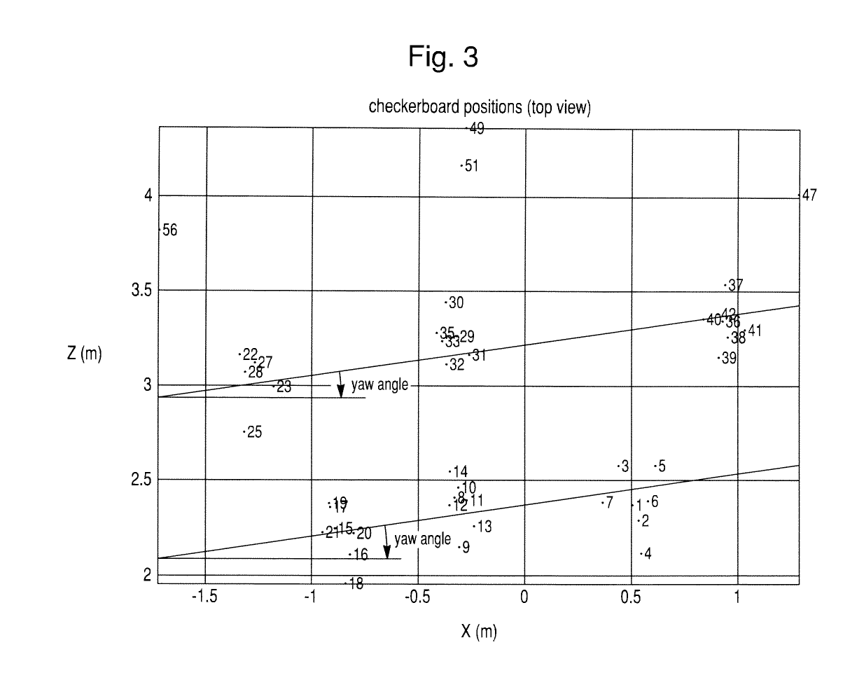

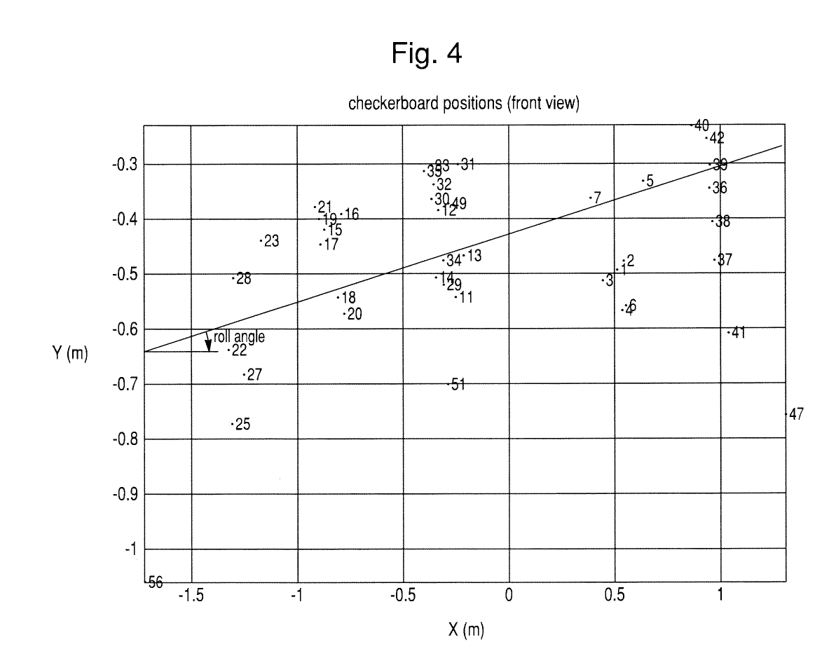

Since these checkerboard positions are aligned at the same elevation and predefined downrange, with the calibration software estimating these 3D positions in the optimization process, we can then calculate the pitch, yaw, and roll angles using the estimated parameters. Example of estimated checkerboard positions are shown in FIG. 2 (side view for pitch angle calculation), FIG. 3 (top view for yaw angle calculation), and FIG. 4 (front view for roll angle calculation). The numbers in the figures are image numbers.

This camera pitch, yaw, roll angle estimation method can be implemented in the calibration software so that it can be performed automatically once the ground truth is known.

Compared to conventional calibration methods, the embodiments of the present disclosure can be easy to implement in software and can be calculated automatically, whereby no extra steps are needed to obtain camera rotation angles once the calibration is done. This saves time and manpower for the total calibration effort.

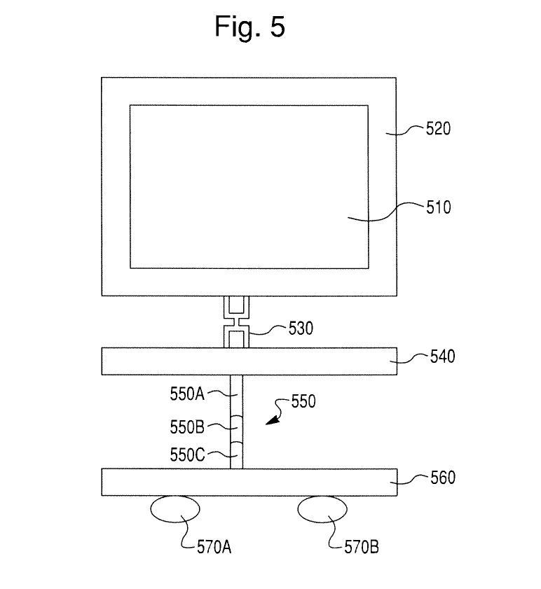

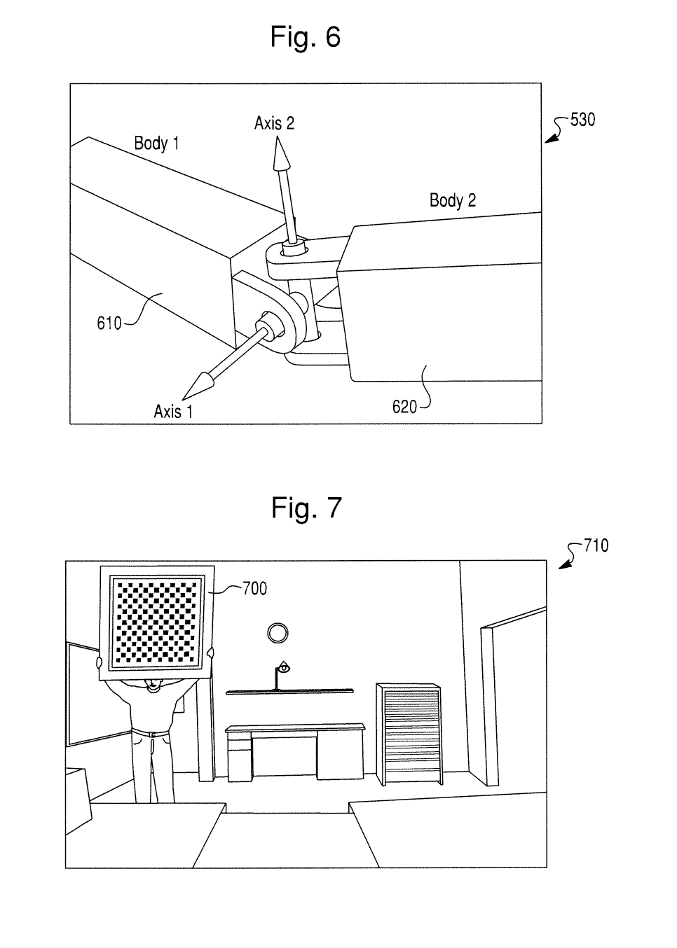

FIG. 5 shows a calibration apparatus 500 according to an exemplary embodiment. The calibration apparatus includes a checkerboard 510, and a frame 520 for stably holding the checkerboard 510 in place on the calibration apparatus 500. The calibration apparatus also includes a rotatable socket 530 connected at one end to the frame 530, whereby the rotatable socket 530 is shown as being connected to a bottom portion of the frame 530. The rotatable socket 530 is connected in a rigid manner to the frame 530, such as by screws, bolts, etc. The rotable socket 530 can be a universal joint, such as one having a structure as shown in FIG. 6, in which a first body 610 and a second body 620 are rotatably connected to each other and can move along two axes (Axis 1, Axis 2) with respect to each other.

Turning back to FIG. 5, the calibration apparatus 500 also includes a stand 540 which is connected to another end of the rotatable socket 530, whereby FIG. 5 shows the stand 540 being connected to a bottom end of the rotatable socket 530. The rotatable socket 530 is connected in a rigid manner to the stand 540, such as by screws, bolts, etc. A height adjusting portion 550 is connected to a bottom surface of the stand 540, whereby the height adjusting portion 550 can be adjusted so that the calibration apparatus 500 can move upwards and downwards. By way of example, the elevation of the checkerboard with respect to a ground surface on which the calibration apparatus 500 is disposed is adjustable in a range of at least 500 mm vertically, and so the height adjusting portion 550 provides for such height adjustment of the checkerboard 510. In the exemplary embodiment shown in FIG. 5, the height adjusting portion 550 is shown as a telescoping device, having three separate portions 550A, 550B, 550C that can be telescoped inwards and outwards with respect to each other. Other types of height adjusting apparatuses may be utilized instead of a telescoping device, while remaining within the spirit and scope of the invention.

The calibration apparatus 500 further includes a platform 560 connected to another end of the stand 540, to provide additional stability for the calibration apparatus 500. The top surface 560 of the platform is fixedly connected to the height adjusting portion 550, such as by screws, bolts, etc. The calibration apparatus also includes wheels 570A, 570B, to allow the calibration apparatus 500 to be easily moved to a particular distance from a device to be calibration, such as a vehicle having a stereo imaging system that needs to be calibrated.

The checkerboard 510 can be tilted and moved to a particular distance and orientation with respect to an image system to be calibrated by the calibration apparatus 500, whereby the tilting can be achieved by setting the rotatable socket 530 to a particular disposition, and whereby once it is set, the rotatable socket 530 stays in that particular position (e.g., a particular disposition of Body 1 and Body 2 of the rotable socket 530 of FIG. 6 with respect to each other) until moved to a different disposition by an operator. By way of example, the rotatable socket 530 may include a lock/unlock feature that allow its separate portions to be moved to a particular disposition with respect to each other when in the “unlocked” state, and then it can be locked in place at that position by an operator pressing a lock/unlock button on the rotatable socket 530. The rotatable socket 530 can later be unlocked to be moved to a different tilt angle, such as by an operator pressing the lock/unlock button of the rotatable socket 530 while it is currently in the “locked” state. The components making up the calibration apparatus 500 may be metal and/or hard plastic parts, so that it is durable and can withstand typical conditions within a car repair garage.

Another aspect of the invention according to some embodiments is described below, with reference to FIGS. 1 and 7-10. In one exemplary embodiment, a method for calibration quality improvement is provided for a camera calibration system. The method identifies outlier images in stereo camera calibration and reduces errors in camera parameter estimation. This allows the system to further identify and remove outlier images and improve estimation accuracy of camera parameters. Further, this is easier to implement in software, or to perform interactively when the ground truth is unknown. This method is used by a camera calibration system for a driver assistance system of a vehicle, according to an exemplary embodiment.

In machine vision applications, because of lens distortion and imperfect lens mounting, camera calibration is a critical step to determine the internal camera geometric and optical characteristics in order to extract accurate metric information from 2D images. Calibration is typically performed by observing and capturing images of a calibration object whose geometry in 3D space is known with very good precision, followed by a parameter estimation process using some calibration software. The most commonly used calibration object is a painted checkerboard with precisely known square size, and corner positions of each square in the image are used in the parameter estimation process. Referring to FIG. 7, one such checkerboard 700 is shown in a high distortion region, with that region corresponding to an office room 710.

The quality of camera calibration, (i.e., the correctness and accuracy of camera parameter estimation) has a direct impact on determining the 3D position and size of an object based on its location and size in the image. This is especially true in stereo vision where far range accuracy is very sensitive to camera parameter errors. Because of image noise in the captured checkerboard images, extracted checker corner positions contain subpixel errors, which in turn result in errors in estimated camera parameters. Camera parameter estimation is normally done through a nonlinear optimization process, in which all intrinsic and extrinsic parameters (typically a few hundred of them) are all estimated simultaneously.

Because of the very high dimensionality of the parameter space and some of the parameters are correlated, a global minimum reached by the optimization process may not give the optimal estimate of the parameters, especially if one or more of the checkerboard images have non-Gaussian noises in its extracted corner positions, or the checkerboard is in an image area that has extra distortion not modeled by the lens distortion model. These “outlier” images tend to negatively affect the optimization process, and contribute errors to the estimated parameters. The challenge that is addressed in this another exemplary embodiment is how to identify these “outlier” images in the parameter estimation process.

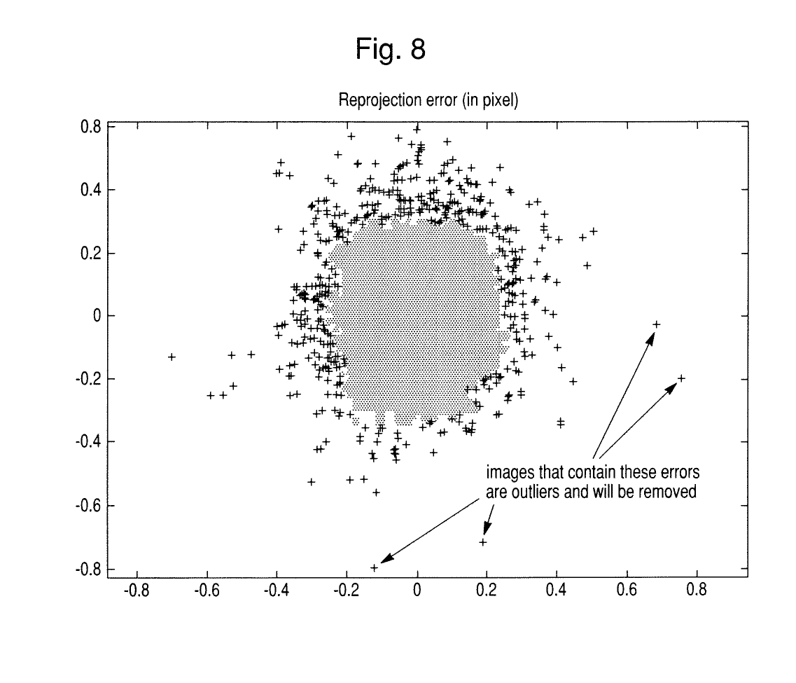

A conventional method of identifying “outlier” images is by observing the reprojection error distribution after the optimization is done. Reprojection errors are calculated as the difference between measured corner positions and projected corner positions based on estimated parameters. A plot showing a typical reprojection error distribution is shown in FIG. 8. Images that generate large reprojection errors will be identified as “outlier” images and hence be removed. Then the optimization process will be repeated to obtain improved parameter estimates.

A problem of the conventional method is that “outlier” images could still exist in the remaining images with small reprojection errors, since the reprojection errors are calculated after the optimization is done which minimizes the reprojection errors. In other words, two parameters that have errors in opposite directions could still make the reprojection errors small.

A different approach for identifying the “outlier” images in the calibration process, as adopted in the another exemplary embodiment, is to utilize some constraints/knowledge on the 3D positions and orientations of the checkerboard poses in the captured images, besides reprojection errors, in outlier identification. The checkerboard images are captured at predefined positions and orientations, which serve as a kind of ground truth. As such, the checkerboard positions and orientations become part of the parameter set and are estimated in the optimization process. That way, after optimization, any checkerboard image with its estimated position and/or orientation far from the ground truth can be identified as an outlier and can be removed. An example of the “known” checkerboard positions is provided in FIG. 1.

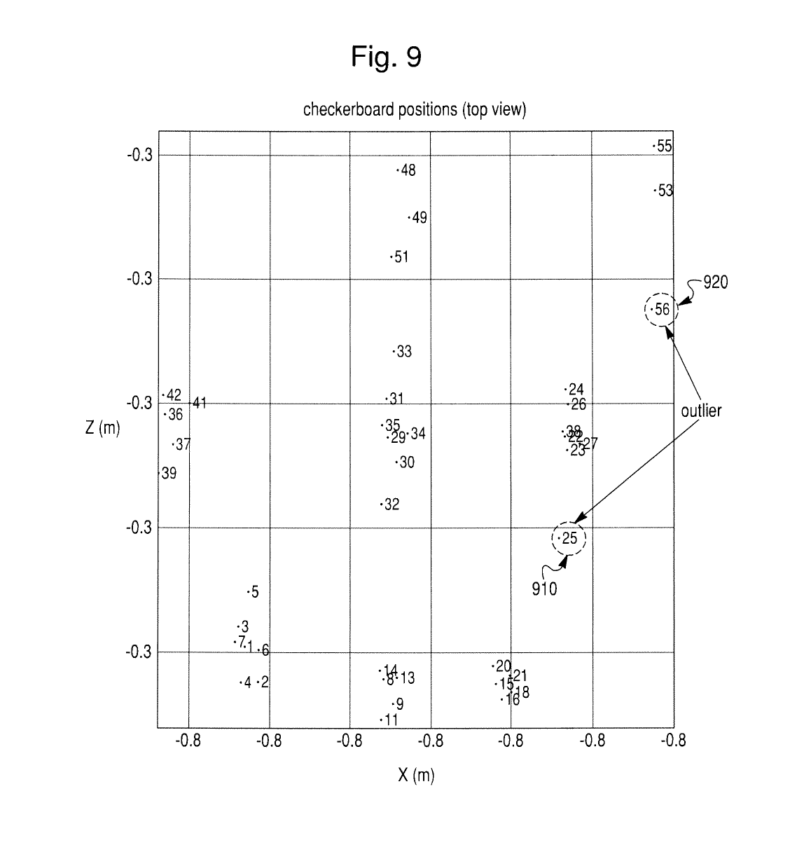

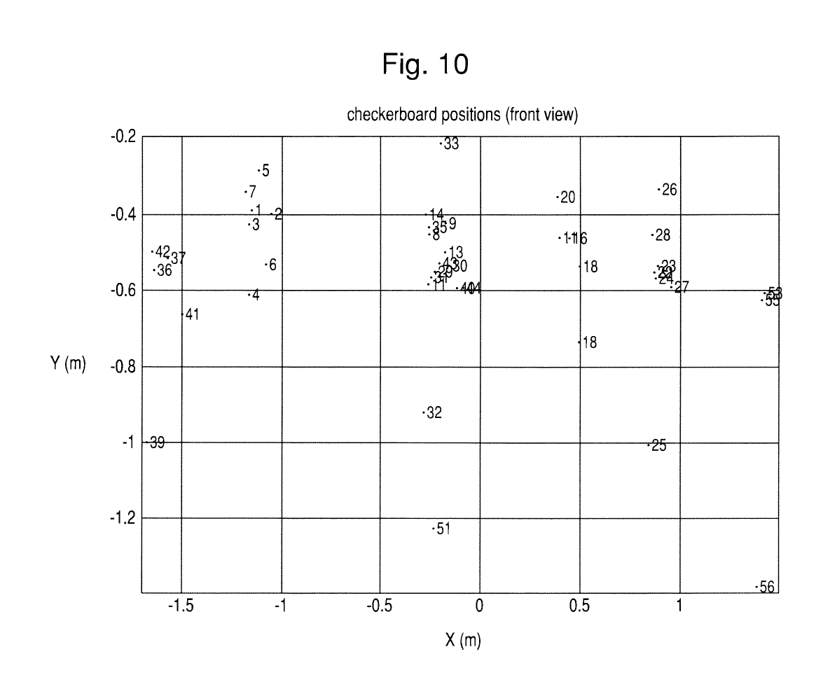

An example of estimated checkerboard positions are shown in FIG. 9 (top view) and FIG. 10 (front view). The numbers in the figures correspond to image numbers. Two outlier images have been identified in FIG. 9 as shown by dashed circles 910, 920 respectively surrounding the two “outlier” image numbers 25, 66. The outlier images are identified due to their position or orientation, or both, being sufficiently far from any of the ‘known’ checkerboard positions (e.g., as shown in FIG. 1) and orientations that form the “ground truth.” The outlier image identification method can be implemented in the calibration software so that it can be performed automatically once the ground truth is known.

The present disclosure has been described with reference to example embodiments, however persons skilled in the art will recognize that changes may be made in form and detail without departing from the spirit and scope of the disclosed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the exemplary embodiments is manifestly intended to be as broad as possible. For example, unless specifically otherwise noted, the exemplary embodiments reciting a single particular element also encompass a plurality of such particular elements.

Exemplary embodiments may include program products comprising computer or machine-readable media for carrying or having machine-executable instructions or data structures stored thereon. Exemplary embodiments illustrated in the methods of the figures may be controlled by program products comprising computer or machine-readable media for carrying or having machine-executable instructions or data structures stored thereon. Such computer or machine-readable media can be any available media which can be accessed by a general purpose or special purpose computer or other machine with a processor. By way of example, such computer or machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of computer or machine-readable media. Computer or machine-executable instructions comprise, for example, instructions and data which cause a general purpose computer, special purpose computer, or special purpose processing machines to perform a certain function or group of functions. Software implementations of the present invention could be accomplished with standard programming techniques with rule based logic and other logic to accomplish the various connection steps, processing steps, comparison steps and decision steps.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present subject matter.

1. A calibration apparatus, comprising:
a calibration target;
a frame configured to hold the calibration target in place;
a rotatable socket connected at one end to the frame;
a stand which is connected to another end of the rotatable socket;
a height adjusting portion connected at one end to the stand; and
a platform connected to another end of the stand,
wherein the calibration target can be tilted and moved to a particular distance and orientation with respect to an image sensor to be calibrated by the calibration apparatus.

2. The calibration apparatus according to claim 1, wherein the rotatable socket comprises a universal joint.

3. The calibration apparatus according to claim 1, wherein the height adjusting portion comprises separate telescoping elements that can be moved inwards and outwards with respect to each other.

4. The calibration apparatus according to claim 1, further comprising:
a plurality of wheels connected to a bottom surface of the platform,
wherein the calibration apparatus is movable to/from a device to be calibrated at different distances with respect to the device by way of rolling the calibration apparatus to appropriate locations with respect to the device.

5. The calibration apparatus according to claim 1, wherein the calibration target comprises a checkerboard.

6. A calibration apparatus, comprising:
a movable platform;
a calibration target held on the movable platform;
a rotating unit configured to rotate the calibration target on the movable platform; and
a height adjusting unit configured to adjust a height of the calibration target on the movable platform,
wherein the calibration target can be tilted and moved to a particular distance and orientation with respect to an image sensor to be calibrated by the calibration apparatus.

7. The calibration apparatus according to claim 6, wherein the calibration target comprises a checkerboard.

8. A method of calibrating an imaging system of an apparatus, comprising:
placing a calibration target mounted within a frame at a particular distance from the apparatus;
tilting the calibration target to a particular tilt angle with respect to the apparatus at the particular distance from the apparatus;
capturing image data obtained from the apparatus while the calibration target is at the particular distance from the apparatus and at the particular tilt angle;
moving the calibration target to at least one other distance from the apparatus;
tilting the calibration target to a particular tilt angle with respect to the apparatus at the one other distance from the apparatus; and
capturing image data obtained from the apparatus while the calibration target is at the one other distance from the apparatus and at the particular tilt angle.

9. The method according to claim 8, wherein the tilting steps comprise:
adjusting a rotatable joint connected to the frame so as to achieve the tilt of the calibration target at the particular tilt angle.

10. The method according to claim 8, further comprising:
adjusting a height of the calibration target while positioned at the particular distance from the apparatus, to be at a predetermined height with respect to ground.

11. The method according to claim 10, wherein the adjusting comprises:
manipulating a height adjusting portion connected to the calibration target so that the calibration target is positioned at the predetermined height with respect to ground.

12. The method according to claim 11, wherein the height adjusting portion comprises a telescoping device.

13. The method according to claim 9, wherein the rotatable joint comprises a universal joint.

14. The method according to claim 9, wherein the calibration target comprises a checkerboard.

15. An image calibration method, comprising:
capturing predetermined images used during calibration at a plurality of predefined positions and orientations with respect to an imaging sensor to be calibrated;
based on the captured images at the plurality of predefined positions and orientations, forming a parameter set of images;
performing a calibration optimization process which includes obtaining a plurality of images at particular positions and orientations with respect to the imaging sensor to be calibrated; and
using the parameter set of images to determine whether any of the images obtained during the calibration optimization process are to be categorized as outlier images and thereby removed.

16. The image calibration method according to claim 15, wherein an image is determined to be an outlier image when at least one of a position and an orientation of the image is greater than a predetermined distance and a predetermined orientation angle, respectively, with respect to any of the images that form the parameter set of images.

17. The image calibration method according to claim 15, wherein an image is determined to be an outlier image when both a position and an orientation of the image is greater than a predetermined distance and a predetermined orientation angle, respectively, with respect to any of the images that form the parameter set of images.
